(19) United States
(12) Patent Application Publication
(10) Pub. No.: US 2011/0130137 A1
(43) Pub. Date: Jun. 2, 2011

(54) Outage Recovery In Wireless Networks

(75) Inventors: Susan W. Sanders, Bridgewater, NJ (US); Amit Mukhopadhyay, Westfield, NJ (US); Mohamed El-Sayed, Tinton Falls, NJ (US)

(73) Assignee: Alcatel-Lucent USA Inc., Murray Hill, NJ (US)

(21) Appl. No.: 12/641,004

(22) Filed: Dec. 17, 2009

Related U.S. Application Data
(60) Provisional application No. 61/265,636, filed on Dec. 1, 2009.

(51) Int. Cl. H04W 24/00

(52) U.S. Cl. 455/424; 455/446

(57) ABSTRACT

Embodiments are described herein to provide a general approach to wireless outage recovery. One general approach involves network equipment detecting (101) an outage condition for a wireless coverage area. In response to detecting the outage condition, the network equipment adjusts (102) a tilt setting of an antenna at a wireless node having a neighboring wireless coverage area. The wireless node then provides (103) wireless service to at least a portion of the wireless coverage area to mitigate the outage condition. Ideally, the wireless node provides wireless service to one or more areas of high traffic density within the outage area.

### REFERENCE(S) TO RELATED APPLICATION(S)

The present application claims priority from a provisional application Ser. No. 61/265,636, entitled “OUTAGE RECOVERY IN WIRELESS NETWORKS,” filed Dec. 1, 2009, which is commonly owned and incorporated herein by reference in its entirety.

### FIELD OF THE INVENTION

The present invention relates generally to communications and, in particular, to outage recovery in wireless communication systems.

### BACKGROUND OF THE INVENTION

In wireless networks, the outage of a base station creates a coverage hole in the base station's serving area. Hence, wireless service to the subscribers in this area will be interrupted. Until the base station is repaired, subscribers cannot receive service. Such an outage, which could take a substantial amount of time to fix, often results in a loss of revenue and in customer dissatisfaction with the network operator.

One of the goals of proposed Long Term Evolution (LTE) Self Organizing Networks (SON) solutions is to compensate for the coverage loss due to a base station outage. The most common approach proposed is to adjust neighbor list information, so that the neighboring base stations can effectively fill in the coverage hole created by the out-of-service base station. However, this method has its limits since not all the coverage can be filled by neighboring cells simply by adjusting neighbor list information. Thus, an approach that is better able to compensate for coverage loss due to a wireless outage is desirable.

### BRIEF DESCRIPTION OF THE DRAWINGS

FIG. 1 is a logic flow diagram of functionality performed in accordance with various embodiments of the present invention.

FIG. 2 is a logic flow diagram of functionality performed in accordance with various embodiments of the present invention.

FIG. 3 illustrates an example of a high traffic density cluster in a wireless coverage area of a sector.

FIG. 4 illustrates an example of a wireless outage occurring in the sector with the high traffic density cluster illustrated in FIG. 3.

FIG. 5 illustrates an example of extending wireless coverage to the high traffic density cluster affected by the wireless outage.

FIG. 6 is a logic flow diagram of functionality performed in accordance with certain particular embodiments of the present invention.

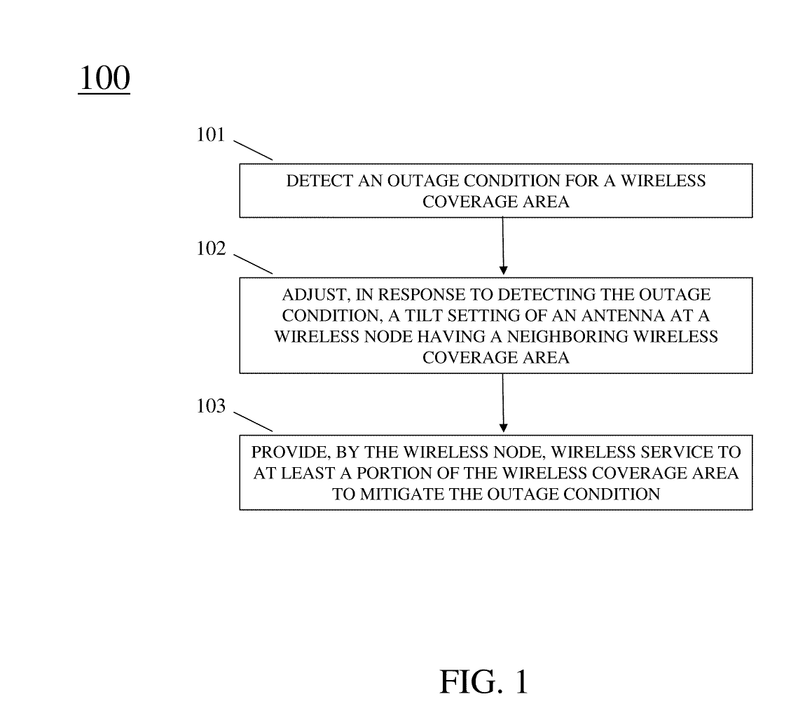

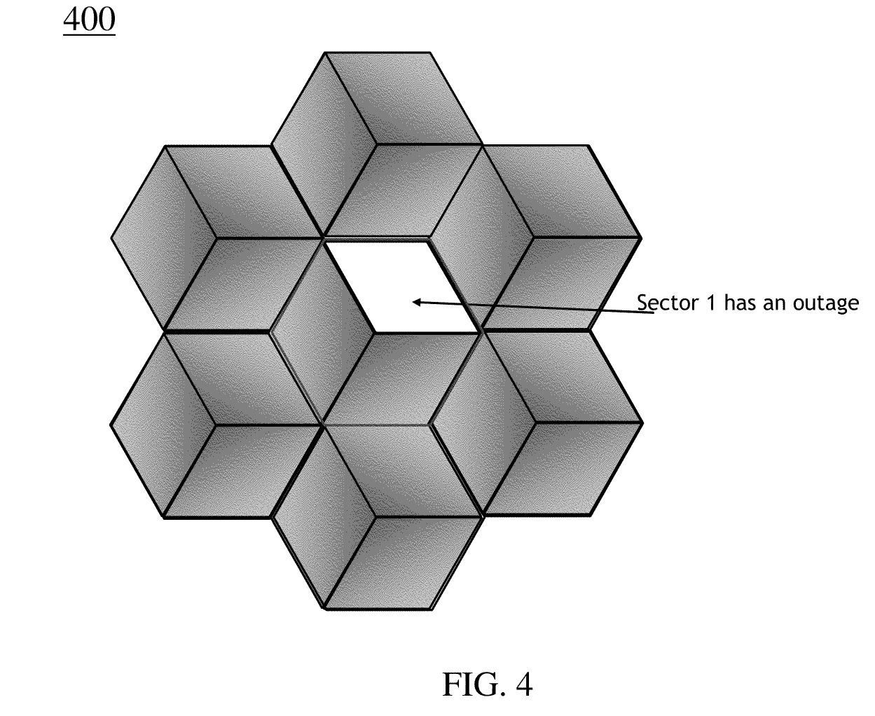

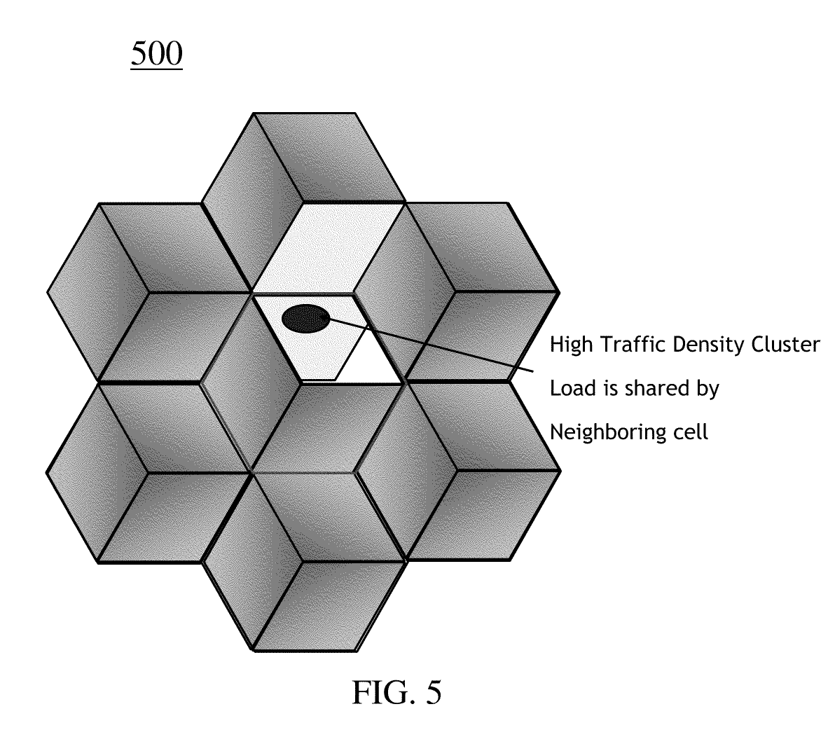

Specific embodiments of the present invention are disclosed below with reference to FIGS. 1-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

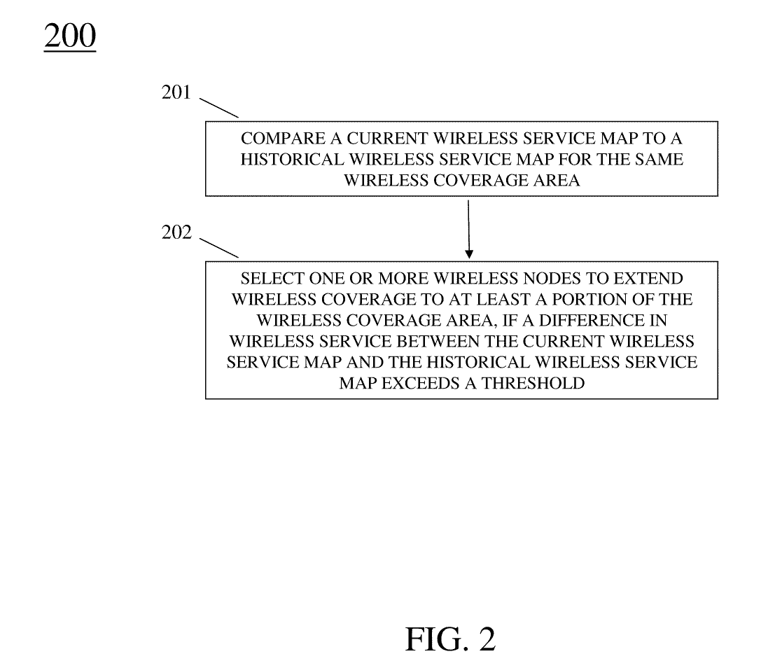

The present invention can be more fully understood with reference to FIGS. 1-6. FIGS. 1 and 2 are logic flow diagrams of functionality performed in accordance with various embodiments of the present invention. Diagrams 100 and 200 serve as a good generalization of many of the embodiments described in detail below. Thus, they are referenced now to provide a preview of the general approach to wireless outage recovery followed by many embodiments of the present invention.

In diagram 100, network equipment detects (101) an outage condition for a wireless coverage area. Depending on the embodiment, the network equipment may simply receive signaling indicating the outage condition is present or it may make such a determination itself. For example, it might compare a current wireless service map to a historical wireless service map and determine that a difference in wireless service between the maps exceeds a threshold. In response to detecting the outage condition, the network equipment adjusts (102) a tilt setting of an antenna at a wireless node having a neighboring wireless coverage area. The wireless node then provides (103) wireless service to at least a portion of the wireless coverage area to mitigate the outage condition. Ideally, the wireless node provides wireless service to one or more areas of high traffic density within the outage area.

In diagram 200, network equipment compares (201) a current wireless service map to a historical wireless service map corresponding to the same wireless coverage area. If a difference in wireless service between the current wireless service map and the historical wireless service map exceeds a threshold, at least one wireless node is selected (202) to extend wireless coverage to at least a portion of the wireless coverage area. Ideally, one or more wireless nodes are selected to at least provide wireless service to areas of high traffic density within the wireless coverage area.

To provide a greater degree of detail in making and using various aspects of the present invention, a description of our approach to wireless outage recovery and a description of certain, quite specific, embodiments follows for the sake of example.

The basic idea underlying some of the embodiments described herein is to use the measurement reporting capability of a subscriber handset coupled with its GPS location reporting capability to create several service maps in a normal operation mode. These maps include subscriber usage maps and RF coverage maps (such as pilot Ec maps, pilot Ec/Io maps, channel quality index (CQI) maps, etc.). These normal operation maps are stored for reference, while current operation maps are created using data collected during the current operation period. When there is an outage (for the serving base station, e.g), network equipment compares current operation maps with their corresponding normal operation maps and determines adjustments for one or more neighboring cells/sectors, such as antenna up tilt, in order that the coverage hole caused by the outage can be best filled by one or more of the neighboring cells/sectors.

The effectiveness of adjustments made during such a recovery process, can then be checked by creating another set of service maps after the adjustments are made. These maps can be compared with the normal operation maps and/or previous current operation maps to determine the degree of recovery that has been achieved. This information may then be used to determine parameter values for the next iteration, if necessary.

These embodiments utilize the reporting capabilities of mobiles (or perhaps fixed wireless units) to generate service maps. In the case of low traffic periods when mobile stations are not actively making phone calls or transmitting data, the network may page units to acquire real-time reports for use in generating a current operation map.

Network equipment such as a server collects measurement and location information, and associates the information geographically into bins, i.e., geo-bins. For example, a geo-bin may be a 10 meter by 10 meter geographical area. The map information for a given geo-bin is computed based on the reports associated with locations falling within that geo-bin. A given service map contains a collection of a certain type (or types) of information associated with each geo-bin included in the map. For example, an RF coverage map may comprise pilot Ec/Io measurements binned geographically, while a usage map may comprise information about traffic patterns binned geographically. The maps may also contain information indicating their time period of collection or may be binned by or their period of collection. For example, this time information or binning may be based upon or indicate a time-of-day, day-of-the-week, time-of-the month, and/or time-of-the-year during which the information was collected.

In some embodiments, the normal operation maps include RF coverage maps and end mobile usage maps. The RF coverage maps can be generated by using drive test data or by using mobile over-the-air RF measurement reports during a normal operation period. This information is coupled with location information indicating where the measurement was collected. The mobile usage maps are created during different periods of the normal operation hours/days/weeks. For a given serving cell/sector the set of mobile usage maps create a usage profile. For example during the weekend, a given geographic bin has a very low voice usage (0.1 Erlangs, as an example). The same location during a weekday busy hour may have a much higher voice usage (1 Erlangs, as an example).

Thus, wireless traffic is not evenly distributed across an entire cell/sector; for example, it can be dense in one area of the cell/sector during morning rush hour, while the same area can have very light traffic during the afternoon rush hour. On the other hand, another area of the cell/sector may have very light traffic during the morning rush hour but heavy traffic during the afternoon rush hour. Hence, the concept of traffic clusters is used herein to capture or reflect the degree of non-uniformity of traffic within a cell/sector. A cluster is a combination of geographic bins that covers a continuous geographic area. When the usage within a geographic bin exceeds a certain threshold (T1), we consider this bin a high traffic density bin. If the percentage of high density bins in the cluster exceeds a certain threshold (T2), we consider this cluster a high traffic density cluster.

When a serving cell/sector has an outage, neighboring cells/sectors can extend their RF coverage by adjusting antenna tilt and/or power. However, neighboring cells need to continue serving the users in their own coverage areas as well. By extending their own coverage, the additional load from the failed cell/sector users could cause overload and/or network congestion. The network equipment attempts to select the best neighboring cell/sector that can cover the high traffic density cluster in the outage area. If a single neighboring cell cannot handle the overall traffic load, or cannot extend RF coverage to the entire high traffic density cluster, then multiple neighboring cells/sectors will be selected to attempt to accomplish the task. Note that there is still a possibility that after exhausting all the choices, some areas of the failed cell/sector may not be covered. The network equipment attempts to minimize the impact of the outage by covering the high traffic density cluster as a high priority. Such an approach attempts to minimize the service interruption to subscribers and allows for adjustment of antennas based on real-time traffic demands.

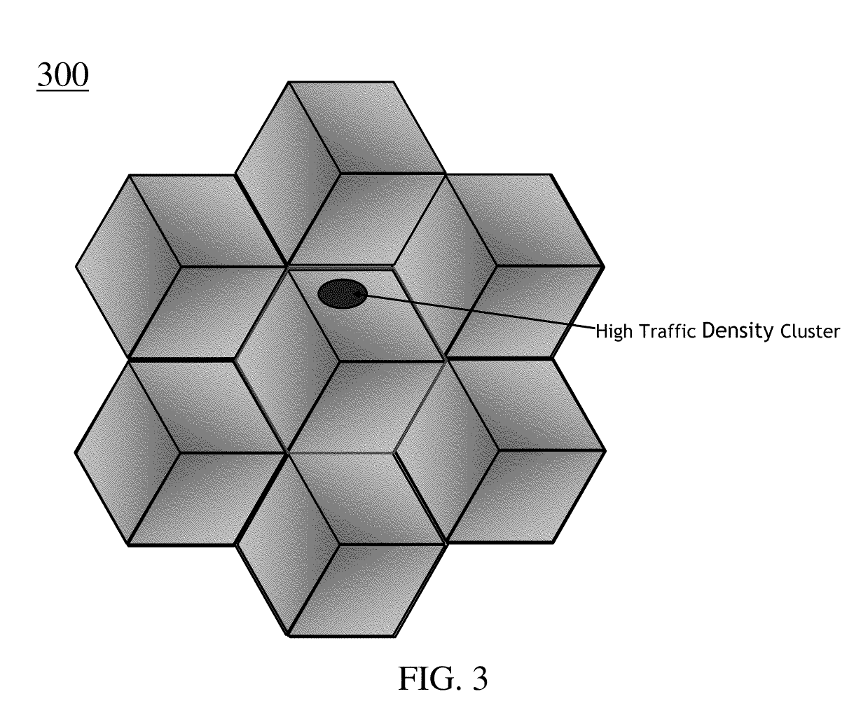

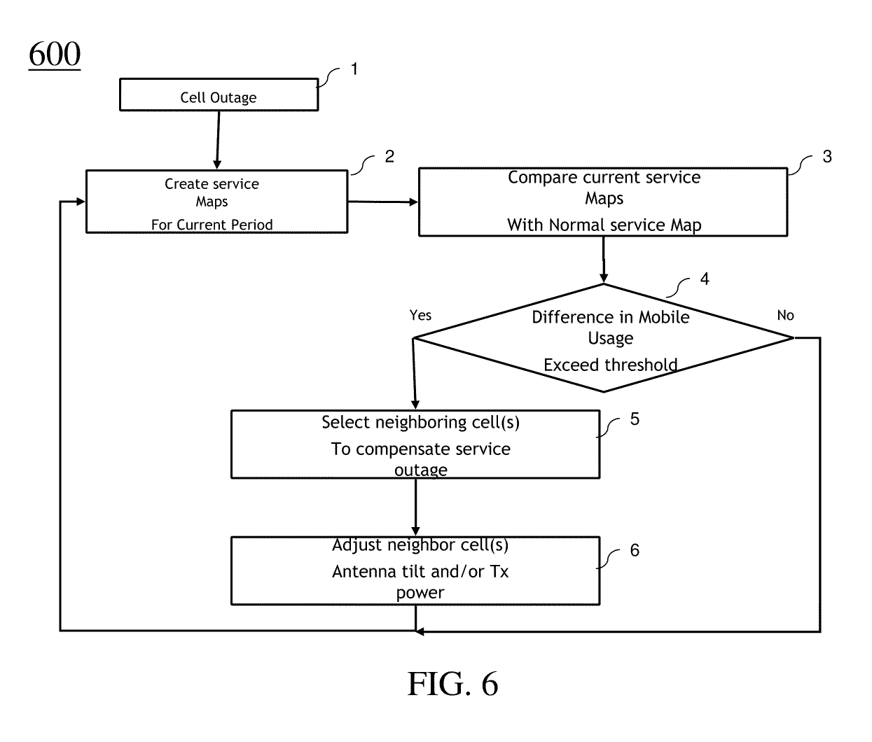

FIG. 6 is a logic flow diagram illustrating certain particular embodiments. Logic flow 600 is described below with reference to FIGS. 3-6:

As a matter of initialization (and also perhaps as an ongoing background task), normal service maps including RF coverage maps and mobile usage maps for different operation hours of the day of the week are created for reference.

Step 1) Base Station develops an outage (see coverage map 400).

Step 2) Create service maps for the current operation period.

Step 3) Compare the current service maps with the Normal Operation service maps. Note the Normal Operation service maps should be the same hour of the day and the same day of the week that were stored on the server.

Step 4) If the difference in mobile usage between two maps exceeds a certain threshold, go to the next step, otherwise go to step 2.

Step 5) Based on Normal Operation Maps, identify high traffic density cluster(s) of the serving cell/sector that currently has an outage (see coverage map 300), select a neighboring cell that can extend RF coverage to the high traffic density cluster without overloading itself (see coverage map 500). If there is no single neighboring cell able to achieve this, select multiple neighboring cells that jointly extend RF coverage to the high traffic density cluster and jointly share the extra traffic load.

Step 6) Adjust the selected neighboring cell parameters such as antenna tilt, transmit power, etc. Then go to step 2. (Although, when the outage cell is brought back to service, restore all parameters back to their Normal Operation mode settings.)

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts. For example, although embodiments described herein are particularly applicable to LTE, UMTS and Cdma2000 wireless networks, the approach and concepts described are applicable to wireless networks generally.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method, comprising:
detecting an outage condition for a wireless coverage area;
adjusting, in response to detecting the outage condition, a tilt setting of an antenna at a wireless node having a neighboring wireless coverage area;
providing, by the wireless node, wireless service to at least a portion of the wireless coverage area to mitigate the outage condition.

2. The method as recited in claim 1, wherein detecting the outage condition for the wireless coverage area comprises:
comparing a current wireless service map to a historical wireless service map, wherein the current wireless service map and the historical wireless service map correspond to the wireless coverage area;
determining that a difference in wireless service between the current wireless service map and the historical wireless service map exceeds a threshold.

3. The method as recited in claim 2, wherein the current wireless service map and the historical wireless service map correspond to similar time periods.

4. The method as recited in claim 2, wherein similar time periods comprise at least one of the same time-of-day, the same day-of-the-week, the same time-of-the month, or the same time-of-the-year.

5. The method as recited in claim 2, further comprising
generating the historical wireless service map using signal measurement reports from wireless units located within a particular geographic location.

6. The method as recited in claim 2, further comprising
generating the historical wireless service map using signal measurement information that includes at least one of pilot Ec, pilot Ec/Io or CQI, the signal measurement information being associated with a particular geographic location.

7. The method as recited in claim 2, further comprising
generating the current wireless service map using signal measurement reports from wireless units located within a particular geographic location.

8. The method as recited in claim 2, further comprising
generating the current wireless service map using signal measurement information that includes at least one of pilot Ec, pilot Ec/Io or CQI, the signal measurement information being associated with a particular geographic location.

9. The method as recited in claim 1, wherein detecting the outage condition for the wireless coverage area comprises:
receiving signaling indicating the outage condition is present for the wireless coverage area.

10. The method as recited in claim 1, further comprising:
adjusting transmit power at the neighboring wireless node in response to detecting the outage condition.

11. The method as recited in claim 1, wherein the at least a portion of the wireless coverage area has been identified as an area of high traffic density.

12. An article of manufacture comprising a processor-readable storage medium storing one or more software programs which when executed by a processor perform the steps of the method of claim 1.

13. A method, comprising:
comparing a current wireless service map to a historical wireless service map, wherein the current wireless service map and the historical wireless service map correspond to a wireless coverage area;
if a difference in wireless service between the current wireless service map and the historical wireless service map exceeds a threshold, selecting at least one wireless node to extend wireless coverage to at least a portion of the wireless coverage area.

14. The method as recited in claim 13, wherein the at least a portion of the wireless coverage area has been identified as an area of high traffic density.

15. The method as recited in claim 14, wherein selecting at least one wireless node to extend wireless coverage comprises
selecting a number of wireless nodes to extend wireless coverage based on a traffic load level associated with the area of high traffic density.

16. An article of manufacture comprising a processor-readable storage medium storing one or more software programs which when executed by a processor perform the steps of the method of claim 13.

17. Network equipment in a communication system, the network equipment being configured to communicate with other equipment in the system, wherein the network equipment is operative to detect an outage condition for a wireless coverage area, to adjust, in response to detecting the outage condition, a tilt setting of an antenna at a wireless node having a neighboring wireless coverage area, and to provide, by the wireless node, wireless service to at least a portion of the wireless coverage area to mitigate the outage condition.

18. The network equipment as recited in claim 17, wherein the network equipment comprises the wireless node.

19. The network equipment as recited in claim 17, wherein being operative to detect the outage condition comprises:
being operative to receive signaling indicating the outage condition is present.
